(19) United States
(12) Patent Application Publication
(10) Pub. No.: US 2018/0183840 A1
(43) Pub. Date: Jun. 28, 2018

(54) METHOD AND APPARATUS FOR SCREEN MIRRORING AND CASTING USING NFC CONNECTION

(71) Applicant: Samsung Display Co., Ltd., Yongin-si (KR)

(72) Inventor: Janghwan Lee, Pleasanton, CA (US)

(21) Appl. No.: 15/405,185

(22) Filed: Jan. 12, 2017

Related U.S. Application Data
(60) Provisional application No. 62/438,817, filed on Dec. 23, 2016.

(51) Int. Cl. H04L 29/06; H04W 8/00; H04W 4/00; H04W 76/02; G06F 3/0488

(52) U.S. Cl. CPC H04L 65/1069; H04W 8/005; H04W 84/12; H04W 76/02; G06F 3/0488; H04W 4/008

(57) ABSTRACT

A system and method for screen mirroring and casting using a near field communication connection to initialize a wireless connection between a client device and a server device. The client device is initially placed in proximity of a near field communication antenna connected to the server device. This proximity triggers the establishing of a near field communication connection, through which setup parameters for a wireless connection are sent, by the server device, to the client device. The wireless connection is then established and used to send video data to the server device, which displays the corresponding video images on a display. The server device may also send user input data to the client device.

### CROSS-REFERENCE TO RELATED APPLICATION(S)

The present application claims priority to and the benefit of U.S. Provisional Application No. 62/438,817, filed Dec. 23, 2016, entitled “METHOD AND APPARATUS FOR SCREEN MIRRORING AND CASTING USING MFC CONNECTION”, the entire content of which is incorporated herein by reference.

### FIELD

One or more aspects of embodiments according to the present invention relate to displaying of video data, and more particularly to a system and method for mirroring and/or casting video from a client device to a remote video display service.

### BACKGROUND

Wireless display technology is an example of a video technology that enables content sharing from a client device such as a mobile device or a personal computer, to a server device (e.g., a wireless display system). Content from the client device may be transmitted over a wireless channel to the server device, e.g., the wireless display system.

A connection between a mobile device and a wireless display may be established if the device user is registered in a certain way, e.g., if the user has previously established permission to use the wireless network to which the display system is connected, and permission to use the display, and if the mobile device has possession of connection information suitable for connecting to the wireless network and to the display system. These conditions may not exist in some situations or environments, such as in classrooms.

Thus, there is a need for a method and apparatus for displaying video data on a server device, by a client device, without previously having registered the client device with the server device.

### SUMMARY

Aspects of embodiments of the present disclosure are directed toward a system and method for screen mirroring and casting using a near field communication connection to initialize a wireless connection between a client device and a server device. The client device is initially placed in proximity of a near field communication antenna connected to the server device. This proximity triggers the establishing of a near field communication connection, through which setup parameters for a wireless connection are sent, by the server device, to the client device. The wireless connection is then established and used to send video data to the server device, which displays the corresponding video images on a display. The server device may also send user input data to the client device.

According to an embodiment of the present invention there is provided a method for displaying, by a first client device, video on a display of a server device, the method including: detecting, by the first client device, a first near field communication connection to the server device; requesting, by the first client device, through the first near field communication connection, information for connecting, by the first client device, to the server device, through a wireless local area network; connecting to the server device, by the first client device, through the wireless local area network; and sending, by the first client device, to the server device, video data.

In one embodiment, the wireless local area network includes a wireless router and the information for connecting, by the first client device, to the server device includes: a service set identifier and a passcode, for connecting to the wireless router.

In one embodiment, the information for connecting, by the first client device, to the server device further includes: an identifier identifying a video coding standard; an internet protocol address for the server device; and a port number.

In one embodiment, the video coding standard is H.265.

In one embodiment, the information for connecting, by the first client device, to the server device, further includes an identifier identifying a name service.

In one embodiment, the first client device is configured, when the first near field communication connection is detected: to display a user interface message, when the first client device is not already connected to the server device, to request an instruction from the user; and to connect to the server device, when the first client device receives from the user an instruction to connect to the server device.

In one embodiment, the first client device is configured, when the first near field communication connection is lost: to display a user interface message to notify a user of the first client device that the first near field communication connection has been lost, and to request an instruction from the user; and to send, to the server device, a connection termination message, when the first client device receives from the user an instruction to disconnect from the server device.

In one embodiment, the first client device is configured, when the connection to the server device through the wireless local area network is lost: to display a user interface message to notify a user of the first client device that the connection to the server device through the wireless local area network has been lost, and to request an instruction from the user; and to submit, to an operating system of the first client device, by an application executing on the first client device, a request to be notified if the connection to the server device through the wireless local area network is restored, when the first client device receives from the user an instruction to reconnect to the server device.

In one embodiment, the method includes: detecting, by a second client device, a second near field communication connection to the server device; requesting, by the second client device, through the second near field communication connection, information for connecting, by the second client device, to the server device, through the wireless local area network; connecting to the server device, by the second client device, through the wireless local area network; and sending, by the second client device, to the server device, video data.

According to an embodiment of the present invention there is provided a system for mirroring and/or casting video data, the system including: a server device including: a near field communication interface; a wireless network interface; and a display, the server device being configured to: establish a first near field communication connection with a first client device; send, through the first near field communication connection, to the first client device, information for connecting, to the server device, through a wireless local area network; receive video data from the first client device, through the wireless local area network; and display, on the display, the video data received from the first client device.

In one embodiment, the system includes a user input device, and the server device is further configured to: detect a user input event; and send, through the wireless local area network, to the first client device, information about the user event.

In one embodiment, the user input event corresponds to a user touching the display.

In one embodiment, the wireless local area network includes a wireless router and the information for connecting, by the first client device, to the server device includes: a service set identifier and a passcode, for connecting to the wireless router.

In one embodiment, the server device is further configured to: assign a first client identifier to the first client device; and send the first client identifier, to the first client device, through the first near field communication connection.

In one embodiment, the server device is further configured to: establish a second near field communication connection with a second client device; send, through the second near field communication connection, to the second client device, information for connecting, to the server device, through a wireless local area network; receive video data from the second client device, through the wireless local area network; and display, on the display, the video data received from the second client device.

In one embodiment, the server device is further configured to: assign a first client identifier to the first client device; send the first client identifier, to the first client device, through the first near field communication connection; assign a second client identifier to the second client device; and send the second client identifier, to the second client device, through the second near field communication connection.

In one embodiment, the displaying, on the display, of the video data received from the first client device includes displaying the video data received from the first client device in a first window; and the displaying, on the display, of the video data received from the second client device includes displaying the video data received from the second client device in a second window.

According to an embodiment of the present invention there is provided a system for mirroring and/or casting video data, the system including: a client device, including: a near field communication interface; and a wireless network interface; the client device being configured to: detect a first near field communication connection to a server device; request through the first near field communication connection, information for connecting, by the client device, to the server device, through a wireless local area network; connect to the server device through the wireless local area network; and send video data to the server device.

In one embodiment, the information for connecting, by the client device, to the server device includes: an identifier identifying a video coding standard; an internet protocol address for the server device; and a port number.

In one embodiment, the client device is configured, when the near field communication connection is detected: to display a user interface message, when the client device is not already connected to the server device, to request an instruction from the user; and to connect to the server device, when the client device receives from the user an instruction to connect to the server device.

### BRIEF DESCRIPTION OF THE DRAWINGS

These and other features and advantages of the present invention will be appreciated and understood with reference to the specification, claims, and appended drawings wherein:

FIG. 1A is a block diagram of a system for screen mirroring and casting, according to an embodiment of the present invention;

FIG. 1B is a block diagram of a system for screen mirroring and casting, according to an embodiment of the present invention;

FIG. 2A is a flowchart of interactions between a client device, a user, and a server device, according to an embodiment of the present invention;

FIG. 2B is a flowchart of interactions between a client device, a user, and a server device, according to an embodiment of the present invention;

FIG. 2C is a flowchart of interactions between a client device, a user, and a server device, according to an embodiment of the present invention; and

FIG. 3 is a flowchart of interactions between a client device and a server device, according to an embodiment of the present invention.

### DETAILED DESCRIPTION

The detailed description set forth below in connection with the appended drawings is intended as a description of exemplary embodiments of a method and apparatus for screen mirroring and casting using an NFC connection provided in accordance with the present invention and is not intended to represent the only forms in which the present invention may be constructed or utilized. The description sets forth the features of the present invention in connection with the illustrated embodiments. It is to be understood, however, that the same or equivalent functions and structures may be accomplished by different embodiments that are also intended to be encompassed within the spirit and scope of the invention. As denoted elsewhere herein, like element numbers are intended to indicate like elements or features.

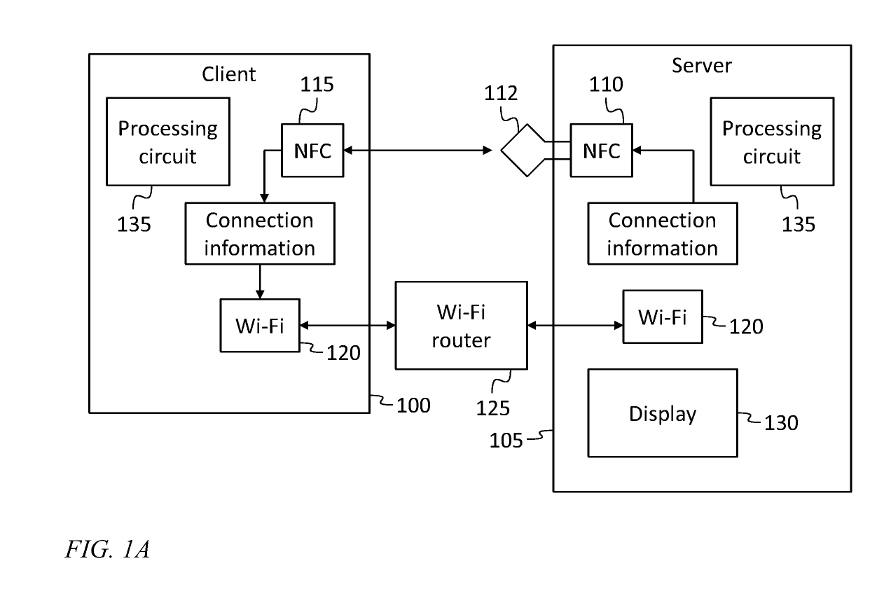

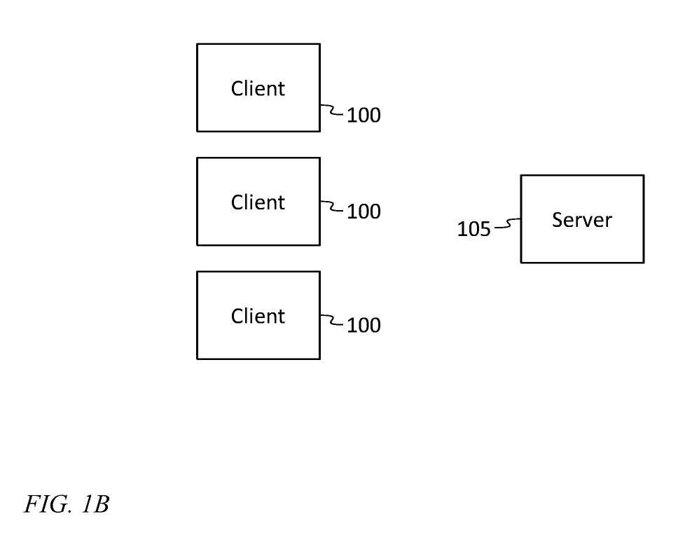

FIG. 1A shows a block diagram of a client device 100 (e.g., a mobile device such as a mobile telephone or a laptop or tablet computer) and a server device 105 (e.g., a wireless display system) connected using connection information provided by the server device in a discovery phase. As discussed in further detail below, the server device 105 includes a near field communication (NFC) interface 110 (e.g., with a near field communication antenna 112), that may be used to establish a near field communication connection with a near field communication interface 115 (or near field communication “tag”) in the client device 100.

Through the near field communication connection the client device 100 requests, and receives, from the server device 105, connection information sufficient to establish a wireless connection between a wireless interface 120 in the client device 100 and a wireless interface 120 in the server device 105, through a wireless local area network, e.g., through a wireless network router 125 (e.g., a Wi-Fi (WI-FI™) router), in addition to the already-established near field communication connection. As used herein, the term “wireless connection” excludes near field communication connections and refers to a communication connection (e.g., a Wi-Fi connection) that is not a near field communication connection. The connection information may include local network information (e.g., a service set identifier (SSID) (which may also be referred to as a network name) and a passcode for the wireless network router 125), protocol information, and a name service identifier. The protocol information may include, for example, an identifier identifying a video communication protocol (e.g., “H.265”, identifying the H.265 protocol, a high efficiency video coding standard), an internet protocol (IP) address for the server device 105, and a port number.

Once the wireless connection is established, it may be used to send, e.g., video data from the client device 100 to the server device 105 for display (e.g., on a display 130 in the server device 105). The wireless connection may also be used to send information in the other direction; for example, if the server device 105 is equipped with a touch-screen display or other user input device (or “human input device”), it may send user touch events to the client device 100 through the wireless connection. In the system shown in FIG. 1A, the presence of the client device 100 in the immediate vicinity of the server device 105 (i.e., sufficiently close to the near field communication antenna 112 of the server device 105 to establish a near field communication connection with the server device 105) may be a sufficient indication that the client device 100 is authorized to use the service, i.e., to connect to the server device 105 and to use the service (e.g., the display service). Accordingly, the need to pre-configure the client device 100 with authentication information may be avoided.

The client device 100 and the server device 105 may each include a processing circuit 135 (described in further detail below) which may be connected to the other elements of the respective device, and which may execute software to perform various tasks, such as the establishing of the near field communication connection and the wireless connection, and the displaying (in the server device 105) of video data on the display 130. A client application may execute in the processing circuit 135 of the client device 100; this application may be responsible for coordinating the setup of the wireless connection, and for the casting and/or mirroring of video to the server device 105. An operating system may also execute in the client device 100; this operating system may provide features through which the client application may interact with the hardware of the client device 100 (e.g., the near field communication interface 115 in the client device 100 and the wireless interface 120 in the client device 100). As used herein, “mirroring” refers to displaying the same video on the display 130 of the server device 105 as is displayed on the client device 100, and “casting” refers to displaying video generated by the client device 100 (and different from the video displayed on the client device 100) on the display 130 of the server device 105. In some embodiments a plurality of client devices 100 may concurrently be connected to the server device 105, and may concurrently use the video display service provided by the server device 105, as illustrated in FIG. 1B.

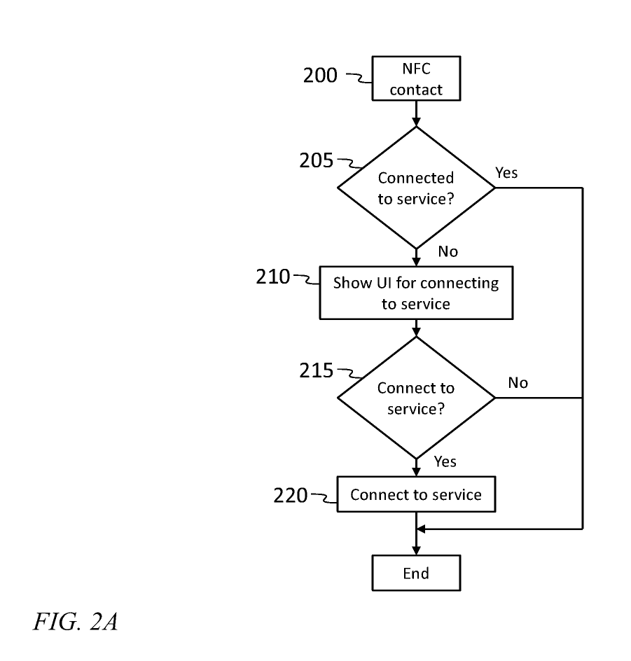

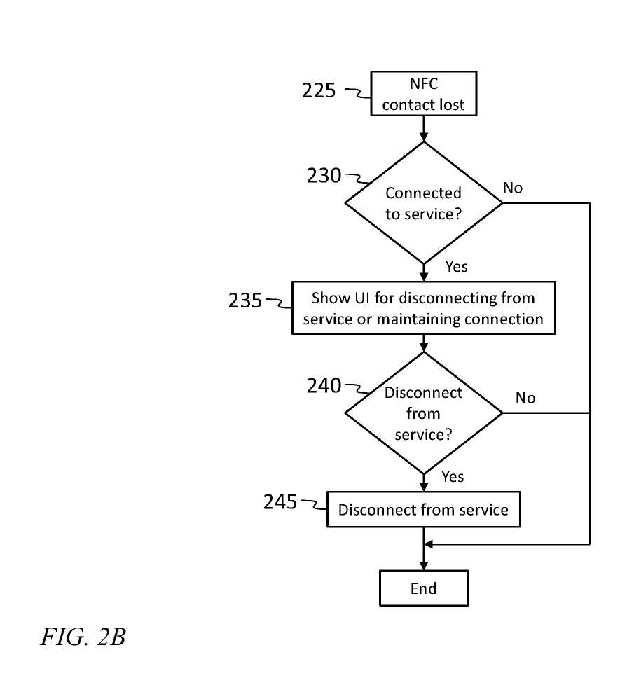

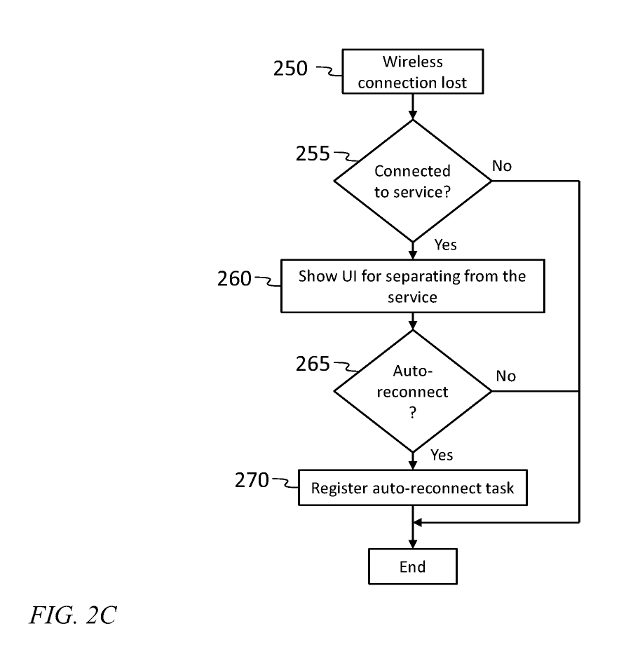

FIGS. 2A-2C shows flowcharts for various situations, including a situation when a near field communication connection is established, when a near field communication connection is lost, and when a wireless connection is lost. In each case the client device 100 may provide a user interface for requesting, and receiving, instructions from the user.

Referring to FIG. 2A, as described above, when, in an act 200, a near field communication connection is established, the client device 100 may determine, in an act 205, whether it is already connected to the service (e.g., the video display service provided by the server device 105); if it is, it may take no further action. If the client device 100 is not already connected to the service, the client device 100 may display to the user, in an act 210, a user interface asking the user whether to connect to the service. If the client device 100 determines, in an act 215, that the user has instructed the client device 100 to connect to the service (e.g., by clicking “Yes” in response to a prompt asking “Do you want to connect to the remote video display?”), it may proceed, in an act 220, to the process of discovering wireless connection parameters and connecting to the service, as described above and as described in further detail below.

Referring to FIG. 2B, when, in an act 225, the near field communication connection is lost (e.g., when the user moves the client device 100 away from the near field communication antenna 112 of the server device 105), the client device 100 may determine, in an act 230, whether it is connected to the service (e.g., the video display service provided by the server device 105); if it is not, it may take no further action. If the client device 100 is connected to the service, the client device 100 may display to the user, in an act 235, a user interface asking the user whether to disconnect from the service. If the client device 100 determines, in an act 240, that the user has instructed the client device 100 to disconnect from the service (e.g., by clicking “Yes” in response to a prompt asking “Do you want to disconnect from the remote video display?”), it may proceed, in an act 245, to disconnect from the service, e.g., by sending a connection termination message to the server device 105, freeing up the service for use by other clients.

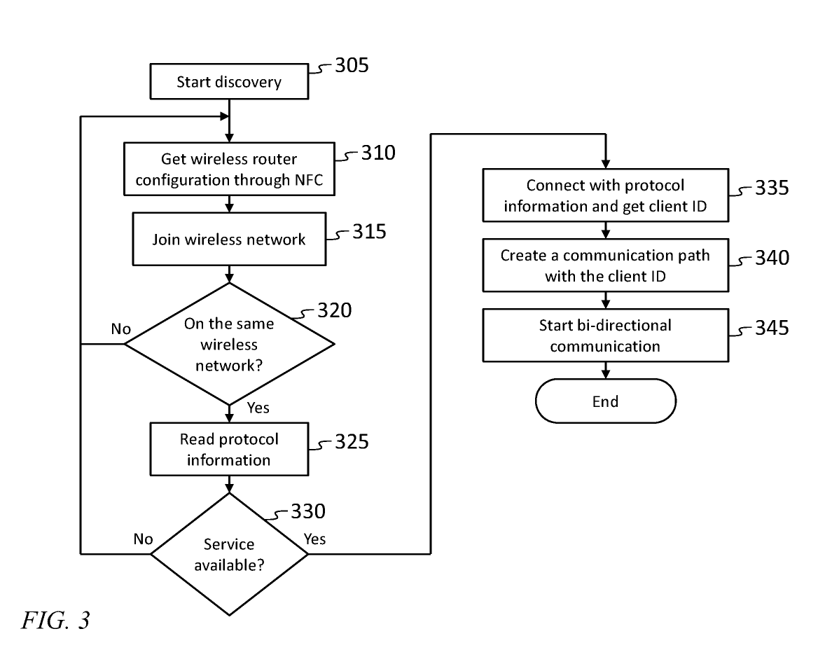

Referring to FIG. 2C, when, in an act 250, the wireless connection is lost, the client device 100 may determine, in an act 255, whether it is connected to the service (e.g., the video display service provided by the server device 105); if it is not, it may take no further action. If the client device 100 is connected to the service, the client device 100 may display to the user, in an act 260, a user interface asking the user whether to separate from the service. If the client device 100 determines, in an act 265, that the user has instructed the client device 100 to separate from the service (e.g., by clicking “Separate” in response to a prompt asking “The wireless connection has been lost. Do you want to separate from the remote video display, or attempt to reconnect?”), it may take no further action. If the client device 100 determines, in the act 265, that the user has instructed the client device 100 to reconnect to the service (e.g., by clicking “Reconnect” in response to the prompt asking “The wireless connection has been lost. Do you want to separate from the remote video display, or attempt to reconnect?”), it may proceed, in an act 270, to attempt to reconnect, by registering an auto-reconnect task. The registering of the auto-reconnect task may involve submitting, by the client application, to the operating system of the client device 100, a notification request, requesting that, when the wireless interface of the client device 100 notifies the operating system of the restoration of the wireless connection, the operating system notify the client application of the restored connection, so that the client application may again begin communicating with the server device 105 (e.g., it may again begin sending video data to the server device 105). Once the client device has rejoined the network it may proceed to re-establish use of the video display service as described in further detail below in the context of FIG. 3. For example, once the client device has rejoined the network, it may execute the method of FIG. 3, beginning with act 320. In some embodiments, when the wireless connection is initially lost, the client device 100 may wait during an interval of time (e.g., 1 second or 5 seconds) before beginning the process illustrated in FIG. 2C.

FIG. 3 is a flowchart of a discovery procedure, in one embodiment. Discovery may begin, in an act 305, when the near field communication interface 115 in the client device 100 detects a signal from the near field communication antenna 112 connected to the near field communication interface 110 in the server device 105, and a near field communication connection is established between the client device 100 and the server device 105. In an act 310, the client device 100 may then obtain, from the server device 105, through the near field communication connection, the configuration of the wireless network router 125, including a service set identifier (SSID) and a passcode.

In an act 315, the client device 100 may then join the wireless network, and, in an act 320, determine whether the wireless network it has joined is the same as the wireless network to which the server device 105 is connected. If the wireless network it has joined is not the same as the wireless network to which the server device 105 is connected, the client device 100 may return to act 310, and attempt to obtain from the server device 105, through the near field communication connection, the configuration of another wireless network router 125, including a service set identifier (SSID) and a passcode. This sequence of events may occur if multiple wireless routers cover the location of the server device 105.

If the wireless network the client device 100 has joined is the same as the wireless network to which the server device 105 is connected, the client device 100 may, in an act 325, read protocol information (e.g., as mentioned above, an identifier identifying a video communication protocol, an internet protocol (IP) address for the server device 105, and a port number), from the server device 105, through the near field communication connection. Once the wireless connection is established, and as long as the near field communication connection remains available, further information may be sent from the server device 105 to the client device 100 through either of the two connections. In one embodiment, the server device 105 sends information to the client device 100 through the near field communication connection if the near field communication connection is available, and through the wireless connection if the near field communication connection is not available.

In some embodiments, the client device 100 obtains from the server device 105, through the near field communication connection, connection information for a name service (hosted by the server device 105 or by another server, e.g., in the wireless router 125), from which it may, using the name of the remote video display service (which may be stored on the client device 100, e.g., in a configuration file read by the client application), obtain the protocol information (in the act 325).

The client device 100 may then, in an act 330, determine whether the video display service is available. The video service may be unavailable, for example, if the client device 100 is not configured to support the video communication protocol specified by the server device 105, or if the video display service is already being used by as many client devices as it can support concurrently. If the client device 100 determines, in the act 330, that the video display service is not available, and if there is a possibility that it may become available, the client device 100 may return to act 310, and repeat acts 310-325 until the service becomes available.

If the client device 100 determines, in the act 330, that the video display service is available, the client device 100 may, in an act 335, connect to the video display service using the protocol information obtained in act 325. It may obtain, from the server device 105, through the wireless connection or through the near field communication connection, a unique client identifier (or “client ID”) assigned by the server device 105, and it may, in an act 340, create a bidirectional communication path to the server device 105 using the client ID. For example, packets sent by the client device 100 to the server device 105 through the wireless connection may include the client ID, facilitating the task, when multiple client devices use the service concurrently, of associating, by the server device 105, each service request (e.g., request to display a frame of video) with a client device. Once the bidirectional communication path to the server device 105 is established by the client device 100, the client device 100 may, in an act 345, initiate bidirectional communications, and the client device 100 may begin using the video display service.

In some embodiments, as mentioned above, a plurality of client devices may use the video display service simultaneously. In this case, the unique respective client ID (which may be assigned by the server device 105 to each of the client devices) may be included in each communication and may facilitate the handling, by the server device 105 of display services for the client devices, and may also facilitate the delivery of user input events (e.g., touch or drag events performed by a user on the display 130, or user input events at a mouse or keyboard connected to the server device 105) to the appropriate client device. The server device 105 may, for example, display a plurality of windows on the display 130, each window being reserved for one of the client devices. The contents of each window may then be the video data mirrored or cast to the server device 105 by the corresponding client device. Touch (or drag, or swipe) events (or mouse events) performed by the user within any of the windows may then be relayed, by the server device 105, to the client device corresponding to the window. In some embodiments, different ports may be used to transmit video data to the server device 105, and to transmit user input to the client device 100.

In some embodiments the server device 105 informs the client device 100 of certain parameters or characteristics of the display service (e.g., the display window size, in pixels and/or in length units), through the near field communication connection or through the wireless connection, where the display window size may refer to the size of the entire display 130 if the video data sent by the client is displayed on the entire display 130 or it may refer to the size of a respective window if, e.g., the video data sent by the client is displayed only within a respective window, as described above.

In view of the foregoing, in some embodiments a system and method provides screen mirroring and casting using a near field communication connection to initialize a wireless connection between a client device and a server device. The client device is initially placed in proximity of a near field communication antenna connected to the server device. This proximity triggers the establishing of a near field communication connection, through which setup parameters for a wireless connection are communicated, by the server device, to the client device. The wireless connection is then established and used to send video data to the server device, which displays the corresponding video images on a display. The server device may also send user input data to the client device.

The term “processing circuit” is used herein to include any combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general purpose hardware, such as a CPU, configured to execute instructions stored in a non-transitory storage medium. A processing circuit may be fabricated on a single printed circuit board (PCB) or distributed over several interconnected PCBs. A processing circuit may contain other processing circuits; for example a processing circuit may include two processing circuits, an FPGA and a CPU, interconnected on a PCB. It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section, without departing from the spirit and scope of the inventive concept.

The terminology used herein is for the purpose of describing particular embodiments only and is not intended to be limiting of the inventive concept. As used herein, the terms “substantially,” “about,” and similar terms are used as terms of approximation and not as terms of degree, and are intended to account for the inherent deviations in measured or calculated values that would be recognized by those of ordinary skill in the art. As used herein, the term “major component” means a component constituting at least half, by weight, of a composition, and the term “major portion”, when applied to a plurality of items, means at least half of the items.

As used herein, the singular forms “a” and “an” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the inventive concept refers to “one or more embodiments of the present invention”. Also, the term “exemplary” is intended to refer to an example or illustration. As used herein, the terms “use,” “using,” and “used” may be considered synonymous with the terms “utilize,” “utilizing,” and “utilized,” respectively.

It will be understood that when an element or layer is referred to as being “on”, “connected to”, “coupled to”, or “adjacent to” another element or layer, it may be directly on, connected to, coupled to, or adjacent to the other element or layer, or one or more intervening elements or layers may be present. In contrast, when an element or layer is referred to as being “directly on”, “directly connected to”, “directly coupled to”, or “immediately adjacent to” another element or layer, there are no intervening elements or layers present.

Although exemplary embodiments of a method and apparatus for screen mirroring and casting using an NFC connection have been specifically described and illustrated herein, many modifications and variations will be apparent to those skilled in the art. Accordingly, it is to be understood that a method and apparatus for screen mirroring and casting using an NFC connection constructed according to principles of this invention may be embodied other than as specifically described herein. The invention is also defined in the following claims, and equivalents thereof.

What is claimed is:

1. A method for displaying, by a first client device, video on a display of a server device, the method comprising:
detecting, by the first client device, a first near field communication connection to the server device;
requesting, by the first client device, through the first near field communication connection, information for connecting, by the first client device, to the server device, through a wireless local area network;
connecting to the server device, by the first client device, through the wireless local area network; and
sending, by the first client device, to the server device, video data.

2. The method of claim 1, wherein the wireless local area network comprises a wireless router and wherein the information for connecting, by the first client device, to the server device comprises:
a service set identifier and a passcode, for connecting to the wireless router.

3. The method of claim 2, wherein the information for connecting, by the first client device, to the server device further comprises:
an identifier identifying a video coding standard;
an internet protocol address for the server device; and
a port number.

4. The method of claim 3, wherein the video coding standard is H.265.

5. The method of claim 3, wherein the information for connecting, by the first client device, to the server device, further comprises an identifier identifying a name service.

6. The method of claim 1, wherein the first client device is configured, when the first near field communication connection is detected:
to display a user interface message, when the first client device is not already connected to the server device, to request an instruction from the user; and
to connect to the server device, when the first client device receives from the user an instruction to connect to the server device.

7. The method of claim 1, wherein the first client device is configured, when the first near field communication connection is lost:
to display a user interface message to notify a user of the first client device that the first near field communication connection has been lost, and to request an instruction from the user; and
to send, to the server device, a connection termination message, when the first client device receives from the user an instruction to disconnect from the server device.

8. The method of claim 1, wherein the first client device is configured, when the connection to the server device through the wireless local area network is lost:
to display a user interface message to notify a user of the first client device that the connection to the server device through the wireless local area network has been lost, and to request an instruction from the user; and
to submit, to an operating system of the first client device, by an application executing on the first client device, a request to be notified if the connection to the server device through the wireless local area network is restored, when the first client device receives from the user an instruction to reconnect to the server device.

9. The method of claim 1, further comprising:
detecting, by a second client device, a second near field communication connection to the server device;
requesting, by the second client device, through the second near field communication connection, information for connecting, by the second client device, to the server device, through the wireless local area network;
connecting to the server device, by the second client device, through the wireless local area network; and
sending, by the second client device, to the server device, video data.

10. A system for mirroring and/or casting video data, the system comprising:
a server device comprising:
a near field communication interface;
a wireless network interface; and
a display,
the server device being configured to:
establish a first near field communication connection with a first client device;
send, through the first near field communication connection, to the first client device, information for connecting, to the server device, through a wireless local area network;
receive video data from the first client device, through the wireless local area network; and
display, on the display, the video data received from the first client device.

11. The system of claim 10, further comprising a user input device, and wherein the server device is further configured to:
detect a user input event; and
send, through the wireless local area network, to the first client device, information about the user event.

12. The system of claim 11, wherein the user input event corresponds to a user touching the display.

13. The system of claim 10, wherein the wireless local area network comprises a wireless router and wherein the information for connecting, by the first client device, to the server device comprises:
a service set identifier and a passcode, for connecting to the wireless router.

14. The system of claim 10, wherein the server device is further configured to:
assign a first client identifier to the first client device; and
send the first client identifier, to the first client device, through the first near field communication connection.

15. The system of claim 10, wherein the server device is further configured to:
establish a second near field communication connection with a second client device;
send, through the second near field communication connection, to the second client device, information for connecting, to the server device, through a wireless local area network;
receive video data from the second client device, through the wireless local area network; and
display, on the display, the video data received from the second client device.

16. The system of claim 15, wherein the server device is further configured to:
assign a first client identifier to the first client device;
send the first client identifier, to the first client device, through the first near field communication connection;
assign a second client identifier to the second client device; and
send the second client identifier, to the second client device, through the second near field communication connection.

17. The system of claim 16, wherein:
the displaying, on the display, of the video data received from the first client device comprises displaying the video data received from the first client device in a first window; and
the displaying, on the display, of the video data received from the second client device comprises displaying the video data received from the second client device in a second window.

18. A system for mirroring and/or casting video data, the system comprising:
a client device, comprising:
a near field communication interface; and
a wireless network interface;
the client device being configured to:
detect a first near field communication connection to a server device;
request through the first near field communication connection, information for connecting, by the client device, to the server device, through a wireless local area network;
connect to the server device through the wireless local area network; and
send video data to the server device.

19. The system of claim 18, wherein the information for connecting, by the client device, to the server device comprises:
an identifier identifying a video coding standard;
an internet protocol address for the server device; and
a port number.

20. The system of claim 18, wherein the client device is configured, when the near field communication connection is detected:
to display a user interface message, when the client device is not already connected to the server device, to request an instruction from the user; and
to connect to the server device, when the client device receives from the user an instruction to connect to the server device.
